(19) United States
(12) Patent Application Publication
(10) Pub. No.: US 2023/0241515 A1
(43) Pub. Date: Aug. 3, 2023

(54) INFORMATION PROCESSING METHOD AND INFORMATION PROCESSING APPARATUS

(71) Applicant: Fujitsu Limited, Kawasaki-shi (JP)

(72) Inventors: Hayato DAN, Yokohama (JP); Masatoshi OGAWA, Zama (JP)

(73) Assignee: Fujitsu Limited, Kawasaki-shi (JP)

(21) Appl. No.: 17/975,755

(22) Filed: Oct. 28, 2022

(30) Foreign Application Priority Data
Jan. 31, 2022 (JP) 2022-013094

(51) Int. Cl. A63F 13/822; A63F 13/45

(52) U.S. Cl. CPC A63F 13/822; A63F 13/45; A63F 2300/807; A63F 2300/638

(57) ABSTRACT

A non-transitory computer-readable recording medium stores a program for causing a computer to execute a process, the process includes in a case of calculating an equilibrium solution of selection probabilities of a plurality of strategies using replicator dynamics, calculating a differential value of a calculation result based on the replicator dynamics using, as an input, respective selection probabilities of the plurality of strategies and respective gains when a game is performed with the respective selection probabilities, and adjusting the respective selection probabilities after elapse of a predetermined time based on the differential value.

### CROSS-REFERENCE TO RELATED APPLICATION

This application is based upon and claims the benefit of priority of the prior Japanese Patent Application No. 2022-013094, filed on Jan. 31, 2022, the entire contents of which are incorporated herein by reference.

### FIELD

The embodiment discussed herein is related to an information processing method and an information processing apparatus.

### BACKGROUND

There is a technique using replicator dynamics as a technique for deriving an evolutionarily stable strategy in a two-player strategic form game or the like. In the following descriptions, the two-player strategic form game or the like will be simply referred to as a game.

An equilibrium solution is obtained by applying the replicator dynamics to the game and repeating update of a strategy evolutionarily. It is known that the equilibrium solution obtained at this time is an evolutionarily stable strategy.

Therefore, it is possible to derive an evolutionarily stable strategy by actually applying the replicator dynamics to the game and observing where it converges to equilibrium.

FIG. 11 is a diagram illustrating an exemplary application of the replicator dynamics. For example, it is assumed that an auction is held for a certain product by an offer of a manufacturer side and a bid of a retailer side so that a transaction price and sales volume are determined. Manufacturer_A1, manufacturer_A2, . . . , and manufacturer_An (n is a natural number) offer the minimum asking price and sales volume for the product to the auction. On the other hand, retailer_B1, retailer_B2, . . . , and retailer_Bn submit bids in the auction at the highest price and purchase volume they may pay.

The manufacturer_A1, manufacturer_A2, . . . , and manufacturer_An want to sell the product at the highest possible price, whereas the retailer_B1, retailer_B2, . . . , and retailer_Bn want to buy the product at the lowest possible price.

The replicator dynamics is applied in a case of reviewing the institutional design of the auction as appropriate by investigating what kind of equilibrium (product transaction price and purchase volume) is settled when the retailer_B1, retailer_B2, . . . , and retailer_Bn make bids on the basis of the concept illustrated in FIG. 11.

Here, an example of the replicator dynamics will be described. The replicator dynamics is defined by an equation (1). The differential of xᵢ is represented by xᵢ(dot).

\dot{x}ᵢ=xᵢ(pᵢ−p^{T}x) (1)

In the equation (1), xᵢ represents a selection probability of the i-th strategy, or a ratio of groups that have selected the i-th strategy. An equation (2) defines x. Here, the possible range of xᵢ is “0≤xᵢ≤1”, and xᵢ satisfies an equation (3).

$$x = {[ {x}_{1} … {x}_{n} ]}^{T} \qquad ( 2 )$$

$${\sum }_{i}^{n} {x}_{i} = 1 \qquad ( 3 )$$

In the equation (1), pᵢ represents reward for the i-th strategy. An equation (4) defines p.

p=[p₁. . . pₙ]^{T} (4)

When the replicator dynamics defined by the equation (1) is discretized for implementation in a computer, it may be expressed by an equation (5). In the equation (5), k represents a time (or the number of steps or the number of generations). An update width is represented by h. With the update width h set larger, the time until the value of x reaches the equilibrium solution and converges may be shortened. Accordingly, by increasing the update width h, for example, improvement in the convergence speed may be expected.

x(k+1)=xᵢ(k)+hxᵢ(k)(pᵢ(k)−p(k)^{T}x(k)) (5)

International Publication Pamphlet No. WO 2007/066787 and Japanese Laid-open Patent Publication No. 2006-227754 are disclosed as related art.

### SUMMARY

According to an aspect of the embodiment, a non-transitory computer-readable recording medium stores a program for causing a computer to execute a process, the process includes in a case of calculating an equilibrium solution of selection probabilities of a plurality of strategies using replicator dynamics, calculating a differential value of a calculation result based on the replicator dynamics using, as an input, respective selection probabilities of the plurality of strategies and respective gains when a game is performed with the respective selection probabilities, and adjusting the respective selection probabilities after elapse of a predetermined time based on the differential value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating processing of an existing device;

FIG. 2 is a diagram illustrating processing of an information processing apparatus according to the present embodiment;

FIG. 3 is a diagram illustrating an exemplary control block corresponding to a controller H(k);

FIG. 4 is a diagram (1) illustrating effects of the information processing apparatus according to the present embodiment;

FIG. 5 is a diagram (2) illustrating a problem of an existing technique;

FIG. 6 is a diagram (2) illustrating effects of the information processing apparatus according to the present embodiment;

FIG. 7 is a diagram illustrating a functional configuration of the information processing apparatus according to the present embodiment;

FIG. 8 is a flowchart illustrating a processing procedure of the information processing apparatus according to the present embodiment;

FIG. 9 is a diagram illustrating another exemplary control block corresponding to the controller H(k);

FIG. 10 is a diagram illustrating an exemplary hardware configuration of a computer that implements functions similar to those of the information processing apparatus according to the embodiment;

FIG. 11 is a diagram illustrating exemplary application of replicator dynamics; and

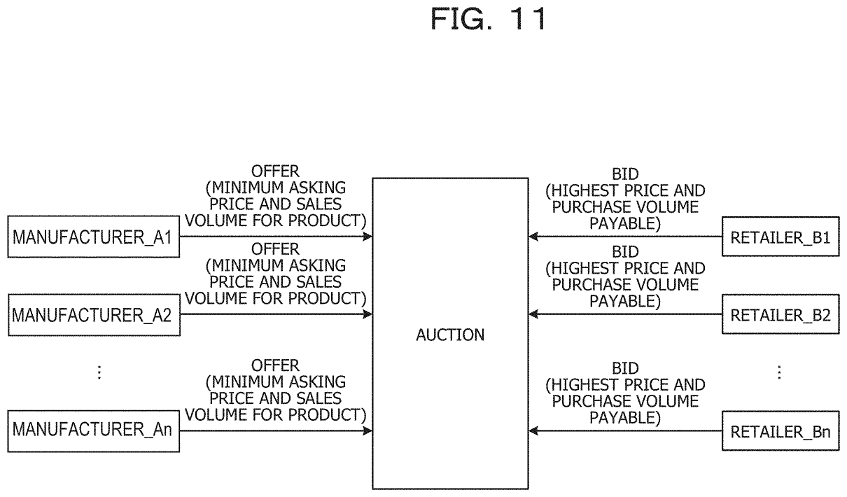

FIG. 12 is a diagram (1) illustrating a problem of the existing technique.

### DESCRIPTION OF EMBODIMENT

As described above, while an increase in the update width h may be expected to improve the convergence speed, a larger update width h may lead to fluctuation.

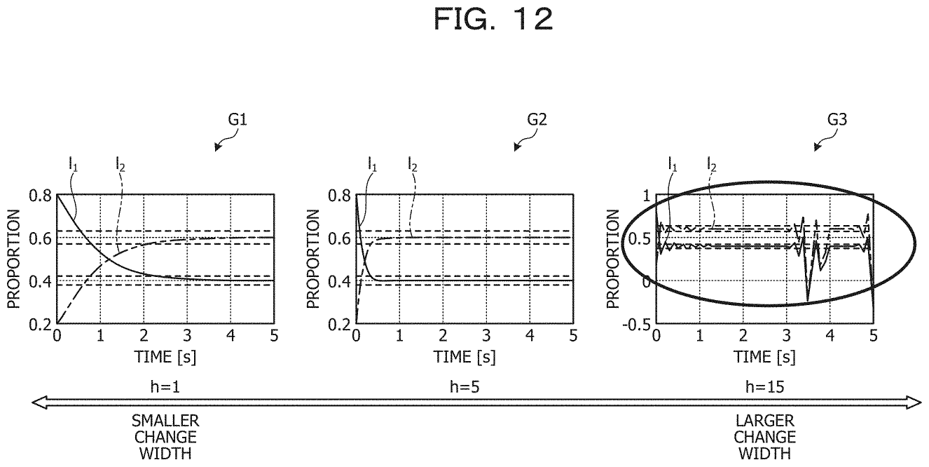

FIG. 12 is a diagram (1) illustrating a problem of an existing technique. A graph G1 indicates a relationship between a time and a proportion (value of xᵢ) when the update width h=1. A graph G2 indicates a relationship between the time and the proportion when the update width h=5. A graph G3 indicates a relationship between the time and the proportion when the update width h=15.

The horizontal axes of the graphs G1, G2, and G3 are axes corresponding to the time, and the vertical axes are axes corresponding to the proportion. As an example, the relationship between the time and the proportion will be described related to x₁ and x₂, which are selection probabilities of first and second strategies. A line l₁ is a line corresponding to xᵢ. A line l₂ is a line corresponding to x₂. The time taken for the value of x to fall within ±5% of a steady-state value may be referred to as a “settling time”.

While the settling time is Time=2 (s) in the graph G1, the settling time is Time=0.3 (s) in the graph G2. That is, as far as the graphs G1 and G2 are concerned, it may be said that an increase in the update width improves the time until convergence.

However, as illustrated in the graph G3, the values of x₁ and x₂ fluctuate and do not converge when the update width h is increased. Furthermore, when the update width h is increased, the condition “0≤xᵢ≤1” may not be satisfied. Accordingly, the existing technique of simply increasing the update width h fails to reduce the time, the number of steps, or the number of generations until convergence to the equilibrium solution.

Hereinafter, an embodiment of an information processing method and an information processing apparatus disclosed in the present application will be described in detail with reference to the drawings. Note that the present embodiment does not limit the present disclosure.

### Embodiment

Prior to explaining an information processing apparatus according to the present embodiment, a device based on an existing technique for calculating replicator dynamics will be described. In the following descriptions, the device based on the existing technique will be referred to as an existing device.

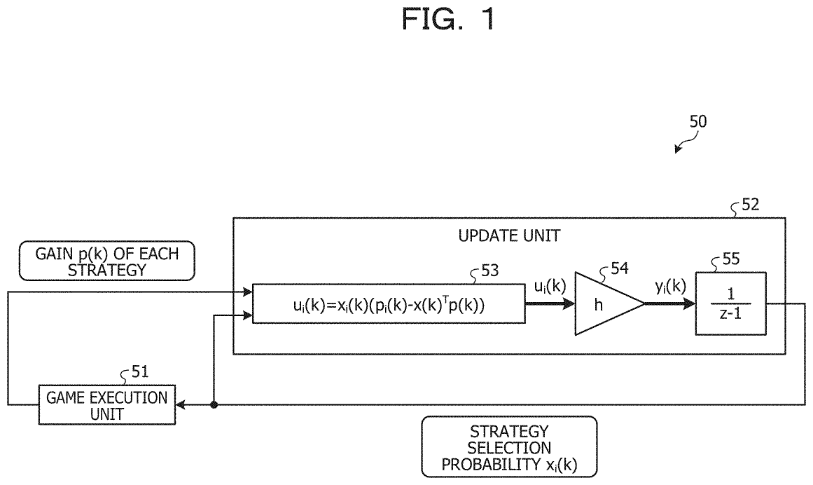

FIG. 1 is a diagram illustrating processing of the existing device. As illustrated in FIG. 1, an existing device 50 includes a game execution unit 51 and an update unit 52. It is assumed that an initial value of a strategy selection probability xᵢ(k) is set in advance.

Upon reception of an input of the strategy selection probability xᵢ(k), the game execution unit 51 executes a predetermined game, and calculates gain p(k) of each strategy with respect to the strategy selection probability xᵢ(k). The game execution unit 51 outputs the gain p(k) of each strategy to the update unit 52.

The update unit 52 outputs a strategy selection probability xᵢ(k+1) with a time advanced by one step on the basis of the strategy selection probability xᵢ(k) and the gain p(k) of each strategy. The update unit 52 includes control blocks 53, 54, and 55.

The control block 53 calculates uᵢ(k) on the basis of the strategy selection probability xᵢ(k), the gain p(k) of each strategy, and an equation (6). The control block 53 outputs uᵢ(k) to the control block 54.

uᵢ(k)=xᵢ(k)(pᵢ(k)−x(k)^{T}p(k)) (6)

The control block 54 multiplies uᵢ(k) by the update width h, thereby calculating yᵢ(k). Here, yᵢ(k) corresponds to a value obtained by subtracting the current strategy selection probability xᵢ(k) from the strategy selection probability xᵢ(k+1) with the time advanced by one step, and corresponds to a change amount of xᵢ. The control block 54 outputs yᵢ(k) to the control block 55.

The control block 55 multiplies yᵢ(k) by (1/(z−1)), thereby calculating the strategy selection probability xᵢ(k+1) for the next time. Here, z is an operator that advances the time by one step. Note that multiplying yᵢ(k) by (1/(z−1)) is the same as executing calculation expressed by an equation (7).

xᵢ(k+1)=xᵢ(k)+yᵢ(k) (7)

According to the existing device 50 described with reference to FIG. 1, while improvement in a convergence speed may be expected by increasing the update width h, when a larger update width h is set, the value of the strategy selection probability xᵢ(k) fluctuates, and the time, the number of steps, or the number of generations to converge to the equilibrium solution may not be reduced, as described with reference to FIG. 12.

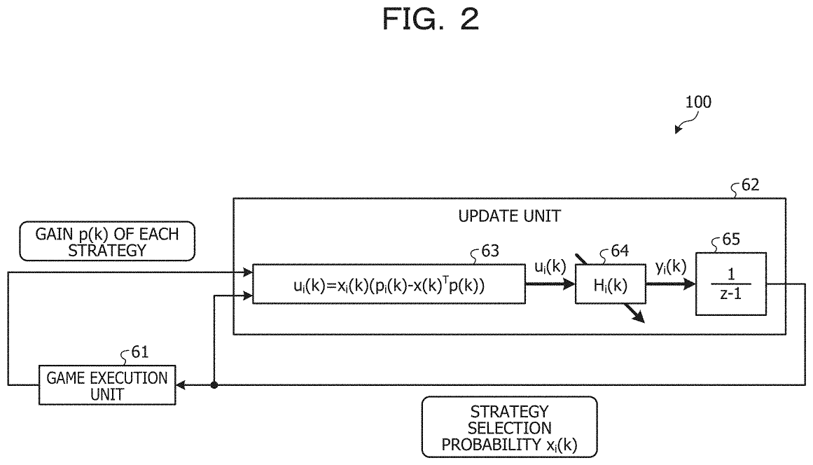

Next, exemplary processing of the information processing apparatus according to the present embodiment will be described. FIG. 2 is a diagram illustrating processing of the information processing apparatus according to the present embodiment. As illustrated in FIG. 2, this information processing apparatus 100 includes a game execution unit 61 and an update unit 62. It is assumed that an initial value of a strategy selection probability xᵢ(k) is set in advance.

Upon reception of an input of the strategy selection probability xᵢ(k), the game execution unit 61 executes a predetermined game, and calculates gain p(k) of each strategy with respect to the strategy selection probability xᵢ(k). The game execution unit 61 outputs the gain p(k) of each strategy to the update unit 62.

The update unit 62 outputs the strategy selection probability xᵢ(k+1) with the time advanced by one step on the basis of the strategy selection probability xᵢ(k) and the gain p(k) of each strategy. The update unit 62 includes control blocks 63, 64, and 65.

The control block 63 calculates uᵢ(k) on the basis of the strategy selection probability xᵢ(k), the gain p(k) of each strategy, and the equation (6). The control block 63 outputs uᵢ(k) to the control block 64.

The control block 64 is a controller H(k) that calculates a differential value of uᵢ(k) and calculates yᵢ(k) with respect to the strategy selection probability xᵢ(k) on the basis of the differential value. Here, yᵢ(k) corresponds to a value obtained by subtracting the current strategy selection probability xᵢ(k) from the strategy selection probability xᵢ(k+1) with the time advanced by one step, and corresponds to a change amount. The control block 64 outputs yᵢ(k) to the control block 65.

The control block 65 multiplies yᵢ(k) by (1/(z−1)), thereby calculating the strategy selection probability xᵢ(k+1) for the next time. Here, z is an operator that advances the time by one step. Note that multiplying yᵢ(k) by (1/(z−1)) is the same as executing calculation expressed by an equation (7).

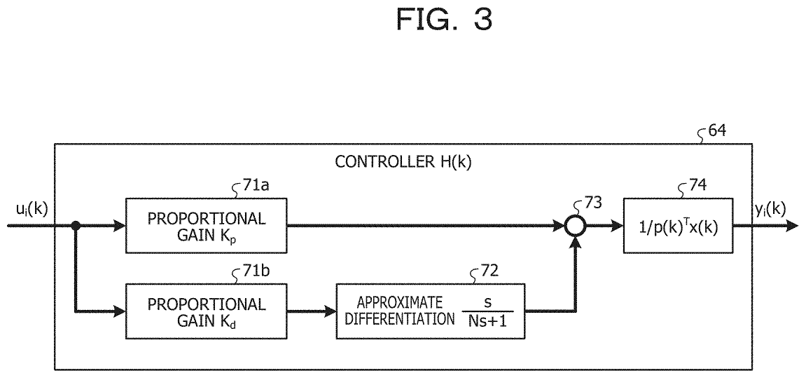

Next, an example of the control block 64 illustrated in FIG. 2 will be described with reference to FIG. 3. The control block 64 corresponds to the controller H(k). FIG. 3 is a diagram illustrating an exemplary control block corresponding to the controller H(k). As illustrated in FIG. 3, the control block 64 (controller H(k)) includes control blocks 71a, 71b, 72, and 74, and an adder 73.

The control block 71a multiplies the input uᵢ(k) by a proportional gain Kₚ, thereby calculating Kₚuᵢ(k). The proportional gain Kₚ is set in advance. The control block 71a outputs Kₚuᵢ(k) to the adder 73.

The control block 71b multiplies the input uᵢ(k) by a proportional gain K_{d}, thereby calculating K_{d}uᵢ(k). The proportional gain K_{d} is set in advance. The control block 71b outputs K_{d}uᵢ(k) to the control block 72.

The control block 72 performs approximate differentiation on K_{d}uᵢ(k). For example, the control block 72 multiplies K_{d}uᵢ(k) by (s/(Ns+1)) to obtain a differential value. Here, s represents a differential operator, and N represents a preset parameter. In the following descriptions, the value obtained by multiplying K_{d}uᵢ(k) by (s/(Ns+1)) will be referred to as a “differential value”. The control block 72 outputs the differential value to the adder 73.

The adder 73 adds Kₚuᵢ(k) and the differential value, and outputs the addition result to the control block 74.

The control block 74 multiplies the addition result obtained from the adder 73 by an adjustment gain, thereby calculating yᵢ(k). For example, the adjustment gain is expressed by an expression (8). The control block 74 outputs yᵢ(k) to the control block 65. In the expression (8), p(k)^{T} represents a transpose of a gain vector p(k). The inner product of the transpose of the gain vector p(k) and a strategy selection probability x(k) is represented by p(k)^{T}x(k).

1/p(k)^{T}x(k) (8)

Here, the control block 64 (controller H(k)) is set in advance to satisfy a relationship of an equation (9) such that a relationship of an equation (10) is satisfied. For example, the control block 74 adjusts yᵢ(k) using the adjustment gain in such a manner that the sum of the change amounts yᵢ(k) with respect to the strategy selection probability xᵢ(k) becomes zero to satisfy the relationship of the equation (10).

$${\sum }_{i}^{n} {x}_{i} ( k + 1 ) = 1 \qquad ( 9 )$$

$${\sum }_{i}^{n} {y}_{i} ( k ) = 0 \qquad ( 10 )$$

As described above, the information processing apparatus 100 according to the present embodiment calculates the differential value of uᵢ(k) calculated on the basis of the strategy selection probability xᵢ(k) and the gain p(k) of each strategy, and adjusts the selection probability of a plurality of strategies after elapse of a predetermined time on the basis of the differential value. For example, as described with reference to FIG. 3, the information processing apparatus 100 calculates the change amount yᵢ(k) using an adjustment gain satisfying the condition that the sum of the individual change amounts yᵢ(k), which is generated on the basis of the addition value of the differential value and Kₚuᵢ(k), becomes zero and generates the strategy selection probability xᵢ(k+1). As a result, it becomes possible to reduce the time, the number of steps, or the number of generations until convergence to the equilibrium solution.

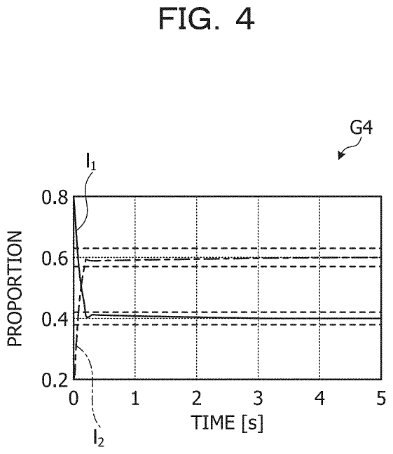

FIG. 4 is a diagram (1) illustrating effects of the information processing apparatus according to the present embodiment. A graph G4 illustrated in FIG. 4 indicates a relationship between a time and a proportion (value of xᵢ) when the information processing apparatus 100 performs processing. The horizontal axis of the graph G4 is an axis corresponding to the time, and the vertical axis is an axis corresponding to the proportion. For example, it is assumed that the gain Kₚ=15, the gain K_{d}=0.5, and N=1. Here, the relationship between the time and the proportion will be described related to x₁ and x₂, which are selection probabilities of first and second strategies. A line l₁ is a line corresponding to x₁. A line l₂ is a line corresponding to x₂.

In the example illustrated in the graph G4, the settling time is 0.2 (s). For example, the settling time may be reduced by approximately 33% as compared with the settling time of 0.3 (s) of the existing technique described with reference to the graph G2 of FIG. 12, in which the update width h=5 is set. That is, it becomes possible to achieve both suppression of fluctuation and improvement in a convergence speed.

Meanwhile, when the replicator dynamics is applied to a game to obtain the equilibrium solution with the existing device, fluctuation may occur depending on the game even when a change width h is made smaller.

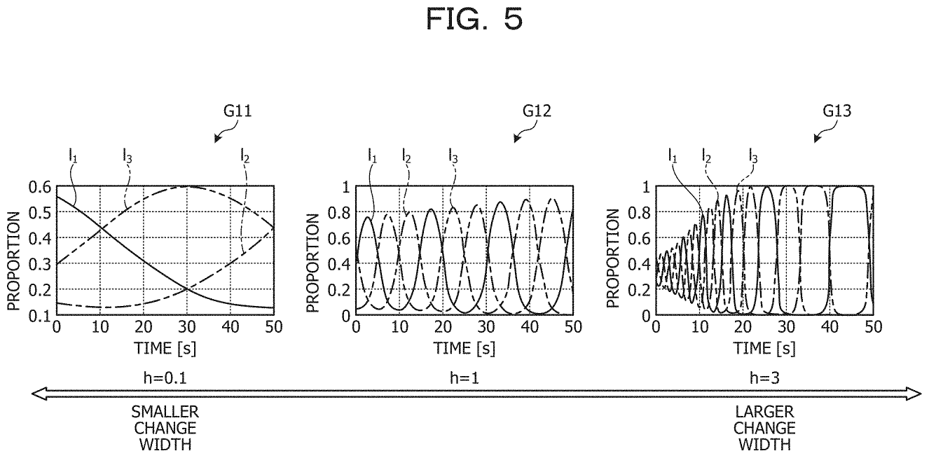

FIG. 5 is a diagram (2) illustrating a problem of an existing technique. A graph G11 indicates a relationship between the time and the proportion (value of xᵢ) when the update width h=0.1. A graph G12 indicates a relationship between the time and the proportion when the update width h=1. A graph G13 indicates a relationship between the time and the proportion when the update width h=3.

The horizontal axes of the graphs G11, G12, and G13 are axes corresponding to the time, and the vertical axes are axes corresponding to the proportion. As an example, the relationship between the time and the proportion will be described related to x₁, x₂, and x₃, which are selection probabilities of first, second, and third strategies. A line l₁ is a line corresponding to x₁. A line l₂ is a line corresponding to x₂. A line l₃ is a line corresponding to x₃. As illustrated in FIG. 5, fluctuation is generated in any of the graphs of the graphs G11, G12, and G13. In such a case, the adjustment of the update width alone may not suppress the fluctuation, and the balance may not be obtained.

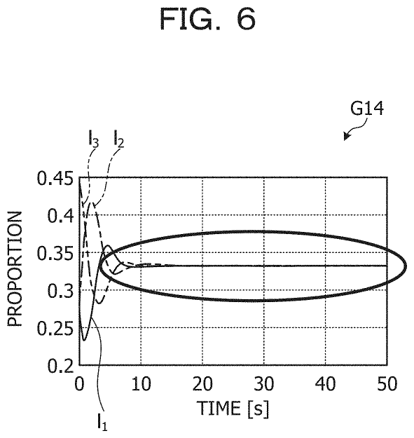

When the information processing apparatus 100 according to the present embodiment applies the replicator dynamics to a game, in which the fluctuation is generated at any change width and the equilibrium solution may not be obtained according to the existing technique described with reference to FIG. 5, to obtain the equilibrium solution, a result illustrated in FIG. 6 is obtained.

FIG. 6 is a diagram (2) illustrating effects of the information processing apparatus according to the present embodiment. A graph G14 illustrated in FIG. 6 indicates a relationship between the time and the proportion (value of xᵢ) when the information processing apparatus 100 performs processing. The horizontal axis of the graph G14 is an axis corresponding to the time, and the vertical axis is an axis corresponding to the proportion. For example, it is assumed that the gain Kₚ=1, the gain K_{d}=1, and N=1. Here, the relationship between the time and the proportion will be described related to x₁, x₂, and x₃, which are the selection probabilities of the first, second, and third strategies, respectively. A line l₁ is a line corresponding to x₁. A line l₂ is a line corresponding to x₂. A line l₃ is a line corresponding to x₃.

As illustrated in the graph G14, with the information processing apparatus 100 provided with the controller H(k) performing the processing, the selection probabilities x₁, x₂, and x₃ converge, and the equilibrium solution may be calculated.

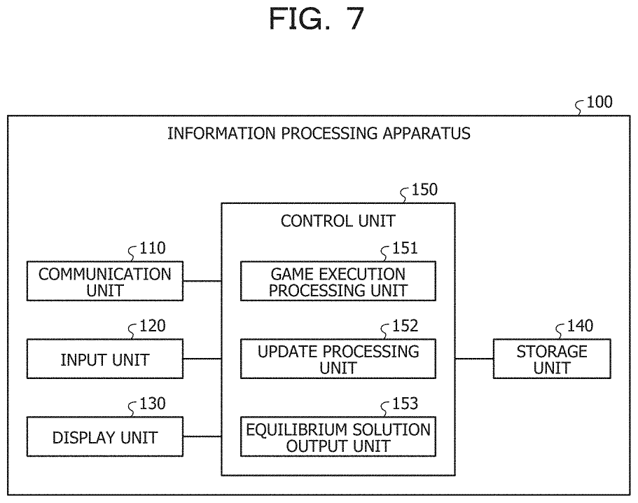

Next, an exemplary configuration of the information processing apparatus 100 according to the present embodiment will be described. FIG. 7 is a diagram illustrating a functional configuration of the information processing apparatus according to the present embodiment. As illustrated in FIG. 7, the information processing apparatus 100 includes a communication unit 110, an input unit 120, a display unit 130, a control unit 150, and a storage unit 140.

The communication unit 110 performs data communication with an external device via a network.

The input unit 120 is an input device that receives an operation from a user, and is implemented by, for example, a keyboard, a mouse, or the like. The user operates the input unit 120 to input information related to game settings, the proportional gains Kₚ and K_{d}, a parameter N to be used to perform approximate differentiation, and the like.

The display unit 130 is a display device for outputting a result of equilibrium solution calculation and the like, and is implemented by, for example, a liquid crystal monitor, a printer, or the like.

The storage unit 140 is a storage device that stores various types of information, and is implemented by, for example, a semiconductor memory element such as a random access memory (RAM), a flash memory, or the like, or a storage device such as a hard disk, an optical disk, or the like. For example, the storage unit 140 stores setting information of the game to which the replicator dynamics is applied, the proportional gains Kₚ and K_{d}, information of the parameter N to be used to perform the approximate differentiation, and the like. Furthermore, the storage unit 140 stores the initial value of the strategy selection probability xᵢ(k).

The control unit 150 is implemented by a processor such as a central processing unit (CPU), a micro processing unit (MPU), or the like, executing various programs stored in a storage device inside the information processing apparatus 100 using the RAM or the like as a work area. Furthermore, the control unit 150 may be implemented by an integrated circuit (IC) such as an application specific integrated circuit (ASIC), a field programmable gate array (FPGA), or the like.

The control unit 150 executes the processing described with reference to FIG. 2. For example, the control unit 150 includes a game execution processing unit 151, an update processing unit 152, and an equilibrium solution output unit 153.

The game execution processing unit 151 performs processing corresponding to that of the game execution unit 61 described with reference to FIG. 2. The game execution processing unit 151 executes a predetermined game on the basis of the strategy selection probability xᵢ(k), and calculates the gain p(k) of each strategy with respect to the strategy selection probability xᵢ(k). The game execution processing unit 151 outputs the calculated gain p(k) of each strategy to the update processing unit 152.

When the game execution processing unit 151 obtains the updated strategy selection probability with the time advanced by one step from the update processing unit 152, it repeatedly performs the process of executing the game again and calculating the gain of each strategy with respect to the updated strategy selection probability. The game execution processing unit 151 obtains the initial value of the strategy selection probability xᵢ(k) from the storage unit 140.

The update processing unit 152 performs processing corresponding to that of the update unit 62 described with reference to FIG. 2. Furthermore, it performs processing corresponding to that of the controller H(k) described with reference to FIG. 3. The update processing unit 152 calculates the strategy selection probability xᵢ(k+1) with the time advanced by one step on the basis of the strategy selection probability xᵢ(k) and the gain p(k) of each strategy.

The update processing unit 152 calculates uᵢ(k) on the basis of the strategy selection probability xᵢ(k), the gain p(k) of each strategy, and the equation (6). The update processing unit 152 calculates a differential value of uᵢ(k), and calculates yᵢ(k) with respect to the strategy selection probability xᵢ(k) on the basis of the differential value. The update processing unit 152 multiplies yᵢ(k) by (1/(z−1)), thereby calculating the strategy selection probability xᵢ(k+1) for the next time.

Furthermore, the update processing unit 152 determines whether or not the strategy selection probability has converged. For example, the update processing unit 152 determines that the strategy selection probability has converged when a difference between the previous strategy selection probability xᵢ(k) and the current strategy selection probability xᵢ(k+1) is less than a threshold value.

When the update processing unit 152 determines that the strategy selection probability has converged, it outputs an equilibrium solution to the equilibrium solution output unit 153 with the strategy selection probability xᵢ(k+1) calculated this time as the equilibrium solution.

On the other hand, when the update processing unit 152 determines that the strategy selection probability has not converged, it outputs the strategy selection probability xᵢ(k+1) calculated this time to the game execution processing unit 151. The update processing unit 152 repeatedly performs the process described above until the strategy selection probability converges.

The equilibrium solution output unit 153 outputs information regarding the equilibrium solution to the display unit 130 when the equilibrium solution is obtained from the update processing unit 152.

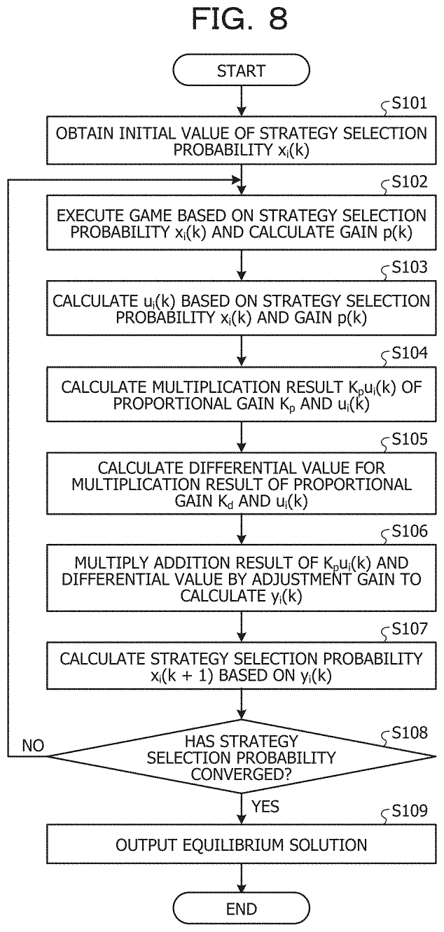

Next, an exemplary processing procedure of the information processing apparatus 100 according to the present embodiment will be described. FIG. 8 is a flowchart illustrating a processing procedure of the information processing apparatus according to the present embodiment. As illustrated in FIG. 8, the game execution processing unit 151 of the information processing apparatus 100 obtains an initial value of the strategy selection probability xᵢ(k) (step S101).

The game execution processing unit 151 executes a game on the basis of the strategy selection probability xᵢ(k), and calculates a gain p(k) (step S102). The update processing unit 152 of the information processing apparatus 100 calculates uᵢ(k) on the basis of the strategy selection probability xᵢ(k) and the gain p(k) (step S103).

The update processing unit 152 calculates a multiplication result Kₚuᵢ(k) of the proportional gain Kₚ and uᵢ(k) (step S104). The update processing unit 152 calculates a differential value for the multiplication result of the proportional gain K_{d} and uᵢ(k) (step S105).

The update processing unit 152 multiplies the addition result of Kₚuᵢ(k) and the differential value by the adjustment gain to calculate yᵢ(k) (step S106). The update processing unit 152 calculates the strategy selection probability xᵢ(k+1) on the basis of yᵢ(k) (step S107).

If the strategy selection probability has not converged (No in step S108), the update processing unit 152 proceeds to step S102. On the other hand, if the strategy selection probability has converged (Yes in step S108), the update processing unit 152 proceeds to step S109.

The equilibrium solution output unit 153 of the information processing apparatus 100 outputs an equilibrium solution to the display unit 130 (step S109).

Next, effects of the information processing apparatus 100 according to the present embodiment will be described. The information processing apparatus 100 calculates the differential value of uᵢ(k) calculated on the basis of the strategy selection probability xᵢ(k) and the gain p(k) of each strategy, and adjusts the selection probability of a plurality of strategies after elapse of a predetermined time on the basis of the differential value. For example, as described with reference to FIG. 3, the information processing apparatus 100 calculates the change amount yᵢ(k) using an adjustment gain satisfying the condition that the sum of the individual change amounts yᵢ(k), which is generated on the basis of the addition value of the differential value and Kₚuᵢ(k), becomes zero and generates the strategy selection probability xᵢ(k+1). As a result, it becomes possible to reduce the time, the number of steps, or the number of generations until convergence to the equilibrium solution.

For example, comparing the graph G4 according to the present embodiment described with reference to FIG. 4 with the graph G2 according to the existing technique described with reference to FIG. 12, the settling time may be reduced by approximately 33% as compared with the settling time of 0.3 (s) of the existing technique in which the update width h=5 is set. For example, it becomes possible to achieve both suppression of fluctuation and improvement in a convergence speed.

Furthermore, as described with reference to FIGS. 5 and 6, according to the information processing apparatus 100, the equilibrium solution may be obtained even for a game in which fluctuation is generated at any change width and the equilibrium solution may not be obtained according to the existing technique.

Meanwhile, although the case where the controller H(k) (control block 64) described in the information processing apparatus 100 according to the present embodiment is implemented by the PD controller and the adjustment gain has been described, it is not limited to this. For example, the information processing apparatus 100 may implement the controller H(k) using a phase-lead compensator.

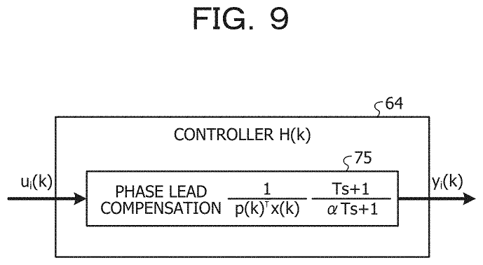

FIG. 9 is a diagram illustrating another exemplary control block corresponding to the controller H(k). As illustrated in FIG. 9, this control block 64 includes a control block 75. The control block 75 executes phase lead compensation. For example, the control block 75 multiplies the input uᵢ(k) by a value expressed by an expression (11), thereby calculating yᵢ(k). In the expression (11), T (time constant) represents a parameter specified in advance.

$$\frac{1}{{p ( k )}^{T} x ( k )} \frac{{T}_{s} + 1}{α T s + 1} \qquad ( 11 )$$

Although an exemplary controller H(k) has been described with reference to FIGS. 3 and 4 in the present embodiment, it is not limited to this. Another controller H(k) may be used as long as the controller H(k) satisfies the relationship of the equation (10).

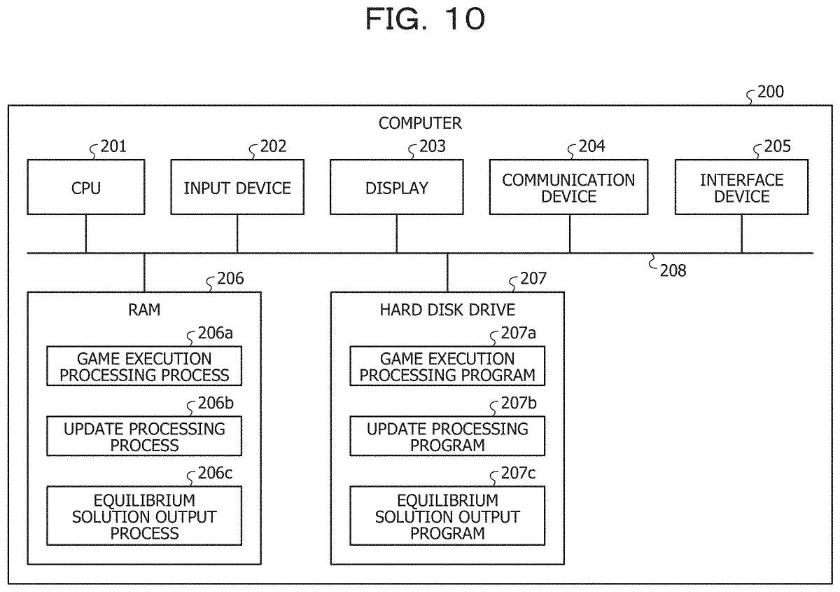

Next, an exemplary hardware configuration of a computer that implements functions similar to those of the information processing apparatus 100 described in the embodiment above will be described. FIG. 10 is a diagram illustrating an exemplary hardware configuration of the computer that implements functions similar to those of the information processing apparatus according to the embodiment.

As illustrated in FIG. 10, a computer 200 includes a CPU 201 that executes various types of arithmetic processing, an input device 202 that receives data input from a user, and a display 203. Furthermore, the computer 200 includes a communication device 204 that exchanges data with an external device or the like via a wired or wireless network, and an interface device 205. Furthermore, the computer 200 includes a RAM 206 that temporarily stores various types of information, and a hard disk drive 207. Then, each of the devices 201 to 207 is coupled to a bus 208.

The hard disk drive 207 stores a game execution processing program 207a, an update processing program 207b, and an equilibrium solution output program 207c. Furthermore, the CPU 201 reads the individual programs 207a to 207c, and loads them into the RAM 206.

The game execution processing program 207a functions as a game execution processing process 206a. The update processing program 207b functions as an update processing process 206b. The equilibrium solution output program 207c functions as an equilibrium solution output process 206c.

Processing of the game execution processing process 206a corresponds to the processing of the game execution processing unit 151. Processing of the update processing process 206b corresponds to the processing of the update processing unit 152. Processing of the equilibrium solution output process 206c corresponds to the processing of the equilibrium solution output unit 153.

Note that the individual programs 207a to 207c may not necessarily be stored in the hard disk drive 207 from the beginning. For example, each of the programs may be stored in a “portable physical medium” to be inserted in the computer 200, such as a flexible disk (FD), a compact disc read-only memory (CD-ROM), a digital versatile disc (DVD), a magneto-optical disk, or an IC card. Then, the computer 200 may read and execute each of the programs 207a to 207c.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
in a case of calculating an equilibrium solution of selection probabilities of a plurality of strategies using replicator dynamics, calculating a differential value of a calculation result based on the replicator dynamics using, as an input, respective selection probabilities of the plurality of strategies and respective gains when a game is performed with the respective selection probabilities; and
adjusting the respective selection probabilities after elapse of a predetermined time based on the differential value.

2. The non-transitory computer-readable recording medium according to claim 1, the process further comprising:
adjusting the respective selection probabilities after the elapse of the predetermined time such that a sum of individual changes with respect to the respective selection probabilities is zero.

3. The non-transitory computer-readable recording medium according to claim 2, the process further comprising:
calculating an inner product of a vector of the respective selection probabilities and a vector of the respective gains; and
outputting a value obtained by dividing the differential value by a value of the inner product as the respective selection probabilities after the elapse of the predetermined time.

4. The non-transitory computer-readable recording medium according to claim 2, the process further comprising:
adjusting the respective selection probabilities after the elapse of the predetermined time based on a result of performing phase lead compensation on the calculation result based on the replicator dynamics.

5. An information processing method, comprising:
in a case of calculating an equilibrium solution of selection probabilities of a plurality of strategies using replicator dynamics, calculating by a computer a differential value of a calculation result based on the replicator dynamics using, as an input, respective selection probabilities of the plurality of strategies and respective gains when a game is performed with the respective selection probabilities; and
adjusting the respective selection probabilities after elapse of a predetermined time based on the differential value.

6. The information processing method according to claim 5, further comprising:
adjusting the respective selection probabilities after the elapse of the predetermined time such that a sum of individual changes with respect to the respective selection probabilities is zero.

7. The information processing method according to claim 6, further comprising:
calculating an inner product of a vector of the respective selection probabilities and a vector of the respective gains; and
outputting a value obtained by dividing the differential value by a value of the inner product as the respective selection probabilities after the elapse of the predetermined time.

8. The information processing method according to claim 6, further comprising:
adjusting the respective selection probabilities after the elapse of the predetermined time based on a result of performing phase lead compensation on the calculation result based on the replicator dynamics.

9. An information processing apparatus, comprising:
a memory; and
a processor coupled to the memory and the processor configured to:
in a case of calculating an equilibrium solution of selection probabilities of a plurality of strategies using replicator dynamics, calculate a differential value of a calculation result based on the replicator dynamics using, as an input, respective selection probabilities of the plurality of strategies and respective gains when a game is performed with the respective selection probabilities; and
adjust the respective selection probabilities after elapse of a predetermined time based on the differential value.

10. The information processing apparatus according to claim 9, wherein
the processor is further configured to:
adjust the respective selection probabilities after the elapse of the predetermined time such that a sum of individual changes with respect to the respective selection probabilities is zero.

11. The information processing apparatus according to claim 10, wherein
the processor is further configured to:
calculate an inner product of a vector of the respective selection probabilities and a vector of the respective gains; and
output a value obtained by dividing the differential value by a value of the inner product as the respective selection probabilities after the elapse of the predetermined time.

12. The information processing apparatus according to claim 10, wherein
the processor is further configured to:
adjust the respective selection probabilities after the elapse of the predetermined time based on a result of performing phase lead compensation on the calculation result based on the replicator dynamics.
